(19) United States
(12) Patent Application Publication
(10) Pub. No.: US 2006/0067073 A1
(43) Pub. Date: Mar. 30, 2006

(54) WHITE LED DEVICE

(76) Inventor: Chu-Chi Ting, Hualien County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,679

(22) Filed: Sep. 30, 2004

(51) Int. Cl. F21V 9/16

(52) U.S. Cl. 362/231; 362/84; 362/235

(57) ABSTRACT

A white LED device is described, including two LED dies capable of emitting a first color light and a second color light, respectively, and a phosphor layer coated on at least one of the two LED dies. The phosphor layer is capable of emitting a third color light when stimulated by the first or second color light, and a light mixing structure is also disposed to mix the first to third color lights into uniform white light without chromatic deviation.

### BACKGROUND OF THE INVENTION

1. Field of the Invention

The present invention relates to a light emitting diode (LED) device. More particularly, the present invention relates to a white LED device that uses two LED dies of different colors to produce three color lights, which are mixed into uniform white light without chromatic deviation.

2. Description of the Related Art

A light emitting diode (LED) functions based on the combination of electrons and holes in semiconductor material, which releases transition energy in the form of light. Since LEDs are small, durable, low in driving voltage and electricity consumption, rapid in response and excellent in anti-shock property and monochromaticity, it is widely applied to various electronic products.

Among various LED devices, the white LED device is a quite promising product to be a “green illuminating source” in replacement of conventional incandescent lamps and fluorescent lamps. The earliest white LED device is proposed by Nichia Corporation, in which a blue LED die is coated with an yttrium aluminum garnet (YAG) fluorescent layer. The YAG layer is stimulated by the blue light to emit complementary yellow light, which is mixed with the blue light to produce white light. However, since the white light lacks a red light component, it looks quite “cold” and makes the colors of illuminated objects unreal. Therefore, the application of the conventional white LED device is restricted, even though its production cost is low and its power supply circuit is easy to design.

To improve the aforementioned problem, some types of tri-wavelength white LED device are developed. One such white LED device use an inorganic UV diode chip to generate an UV light that stimulates phosphors of three primary colors to emit red light, green light and blue light, respectively, which are mixed to produce white light. However, since the inorganic UV diode chip is high-priced, the production cost of the white LED device cannot be easily reduced.

Another type of tri-wavelength white LED device uses three LED dies to generate red light, green light and blue light, respectively, which are mixed into white light. However, since the white LED device includes three LED dies, the production cost and the size thereof cannot be reduced. Moreover, since the driving voltage of the red LED is lower than that of the green or blue LED, an additional driving circuit is required for the red LED.

### SUMMARY OF THE INVENTION

In view of the foregoing, one object of this invention is to provide a white LED device capable of producing uniform white light without chromatic deviation, which can be fabricated using existing equipment without increasing the production cost.

The white LED device of this invention includes two LED dies capable of emitting a first color light and a second color light, respectively, a phosphor layer coated on at least one of the two LED dies, an electrode connection structure and a light mixing structure. The electrode connection structure is electrically connected with the electrodes of the two LED dies for providing electricity to them. The phosphor layer can be stimulated by the first or second color light to emit a third color light, and the first to third color lights are mixed by the light mixing structure to produce uniform white light without chromatic deviation.

In the above white LED device, the two LED dies are preferably a blue LED die and a green LED die, respectively, and the phosphor is preferably a red phosphor layer that emits red light. Since the emitted white light has a red light component, it does not look “cold” and will not make the colors of illuminated objects unreal. In addition, the white LED device does not need any red LED, so that the production cost and the size thereof can be reduced, and an additional driving circuit for controlling a red LED is no more required.

It is to be understood that both the foregoing general description and the following detailed description are exemplary, and are intended to provide further explanation of the invention as claimed.

### BRIEF DESCRIPTION OF THE DRAWINGS

FIG. 1 illustrates a cross-sectional view of a white LED device according to a first embodiment of this invention.

FIG. 2 illustrates a cross-sectional view of a white LED device according to a second embodiment of this invention.

FIG. 3 illustrates a cross-sectional view of a white LED device according to a third embodiment of this invention.

### DESCRIPTION OF THE PREFERRED EMBODIMENTS

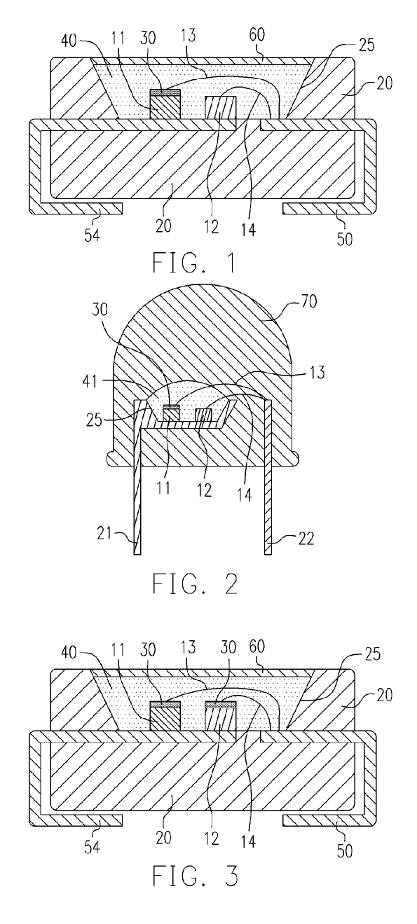

FIG. 1 illustrates a cross-sectional view of a white LED device according to the first embodiment of this invention. Referring to FIG. 1, the white LED device includes a blue LED die 11 and a green LED die 12, wherein one of the two LED dies 11 and 12 is coated with a phosphor layer 30 capable of emitting red light as stimulated by blue or green light. The phosphor layer 30 includes a red phosphor selected from the group consisting of Sr₂Si₅N₈:Eu²⁺, SrS:Eu²⁺, CaS:Eu²⁺ and combinations thereof. The intensity of the emitted red light can be adjusted by varying the thickness of the phosphor layer 30 and/or the amount of red phosphor in the phosphor layer 30. Meanwhile, each of the blue LED die 11 and the green LED die 12 should have a proper light emission intensity, so that the intensities of the red, green and blue lights can be balanced. In addition, though the phosphor layer 30 is disposed on the blue LED die 11 in FIG. 1, the phosphor layer 30 may be disposed on the green LED die 12 alternatively.

The two LED dies 11 and 12 are fixed in a V-shaped groove 25 on a package substrate 20, and one electrode of each of the two LED dies 11 and 12 is connected to a pin 54 extending into the V-shaped groove 25. The other electrode of each of the two LED dies 11 and 12 is connected to another pin 50 extending into the V-shaped groove 25 via a conductive wire 13 or 14. After the wire bonding process, a transparent resin 40 is filled into the V-shaped groove 25 to enclose the two LED dies 11 and 12 and the phosphor layer 30, and the resulting structure is covered with a transparent glass plate 60. The transparent resin 40 and the transparent glass layer 60 together constitute a transparent packaging layer that serves as a light mixing structure.

Referring to FIG. 1 again, when two voltages of opposite polarities are applied to the two pins 50 and 54, respectively, the blue LED die 11 and the green LED die 12 emit blue light and green light, respectively. The blue light emitted from the blue LED die 11 will stimulate the phosphor layer 30 to emit red light, and the blue, green and red lights are mixed into uniform white light without chromatic deviation through the lens effect of the transparent resin 40 and the transparent plate glass 60. Alternatively, when the phosphor layer 30 is disposed on the green LED die 12, the green light emitted from the green LED die 12 will stimulate the phosphor layer 30 to emit red light.

FIG. 2 illustrates a cross-sectional view of a white LED device according to the second embodiment of this invention, which is similar to but different from that of the first embodiment in the following aspects. The two LED dies 11 and 12 are fixed in a V-shaped groove 25 on an electrode frame 21, so that one electrode of each of the two LED dies 11 and 12 is electrically connected to the electrode frame 21. The other electrode of each of the two LED dies 11 and 12 is connected to another electrode frame 22 via a conductive wire 1 3 or 1 4. After the wire bonding process, a transparent resin 41 is filled into the V-shaped groove 25, and the resulting structure is enclosed in a transparent glass bulb 70. The transparent resin 41 and the transparent glass bulb 70 together constitute a transparent packaging layer that serves as a light mixing structure. The mechanism of white light emission is the same as above, and the blue, green and red lights are mixed into white light through the lens effect of the transparent resin 41 and the transparent glass bulb 70.

FIG. 3 illustrates a cross-sectional view of a white LED device according to the third embodiment of this invention, which is different from that of the first embodiment in that another phosphor layer 30 is further disposed on the green LED die 12 so that red light is also produced through green light stimulation. Similarly, the intensity of the red light can be adjusted by varying the thickness of each phosphor layer 30 and/or the amount of red phosphor in each phosphor layer 30. Meanwhile, each of the blue LED die 11 and the green LED die 12 should have a proper light emission intensity, so that the intensities of the red, green and blue lights can be balanced.

Moreover, though the above embodiments are described with RGB-type white LED devices as examples, it is also feasible to use two LED dies and a phosphor layer capable of producing other three color lights if only the three color lights can be mixed to produced white light without chromatic deviation.

In addition, the transparent packaging layer is constituted of a transparent resin and an outer transparent glass layer in the above embodiments, but it may alternatively be constituted of a transparent resin only, a transparent glass layer only, or a transparent glass layer and an outer transparent resin.

Since the white light emitted from the white LED device in each embodiment of this invention has a red light component, it does not look “cold” and will not make the colors of illuminated objects unreal. In addition, the white LED device does not need any red LED, so that the production cost and the size thereof can be reduced, and an additional driving circuit for controlling a red LED is no more required.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A white LED device, comprising:
a first LED die, capable of emitting a first color light;
a second LED die, capable of emitting a second color light; and
a phosphor layer disposed on at least one of the first and second LED dies, capable of emitting a third color light when stimulated by the first or second color light;
an electrode connection structure, electrically connected with electrodes of the first and second LED dies for providing electricity to the first and second LED dies; and
a light mixing structure, capable of mixing the first to third color lights to produce white light.

2. The white LED device according to claim 1, wherein the light mixing structure comprises a transparent packaging layer enclosing
the first LED die, the second LED die and the phosphor layer; and
the first to third color lights are mixed through a lens effect of the transparent packaging layer.

3. The white LED device according to claim 2, wherein the electrode connection structure includes a packaging substrate that have pins electrically connected with the electrodes of the first and second LED dies.

4. The white LED device according to claim 3, wherein
the packaging substrate has a groove therein;
the first and second LED dies are disposed in the groove;
the transparent packaging layer fills the groove; and
the pins comprise:
a first pin extending into the groove, connected with one electrode of each of the first and second LED dies; and
a second pin, connected with the other electrode of each of the first and second LED dies through wire bonding.

5. The white LED device according to claim 4, wherein the transparent packaging layer comprises:
a transparent resin filled in the groove; and
a transparent glass layer disposed on the transparent resin.

6. The white LED device according to claim 2, wherein the electrode connection structure comprises:
a first electrode frame, connected with one electrode of each of the first and second LED dies; and
a second electrode frame, connected with the other electrode of each of the first and second LED dies.

7. The white LED device of claim 6, wherein
the first electrode frame has a groove therein;
the first and second LED dies are disposed in the groove, so that one electrode of each of the first and second LED dies is electrically connected to the first electrode frame;
the transparent packaging layer fills the groove; and
the second electrode frame connect with the other electrode of each of the first and second LED dies through wire bonding.

8. The white LED device according to claim 7, wherein the transparent packaging layer comprises:
a transparent resin filled in the groove; and
a transparent glass layer enclosing the transparent resin.

9. The white LED device according to claim 1, wherein the first LED die comprises a blue LED die, the second LED die comprises a green LED die, and the phosphor layer comprises a red phosphor.

10. The white LED device according to claim 9, wherein the phosphor layer is disposed merely on the blue LED die.

11. The white LED device according to claim 9, wherein the phosphor layer is disposed merely on the green LED die.

12. The white LED device according to claim 9, wherein the phosphor layer is disposed on each of the blue LED die and the green LED die.

13. The white LED device according to claim 9, wherein the phosphor layer includes a red phosphor selected from the group consisting of Sr₂Si₅N₈:eu²⁺, SrS:Eu²⁺, CaS:Eu²⁺ and combinations thereof.
